(19) United States
(12) Patent Application Publication
(10) Pub. No.: US 2002/0077989 A1
(43) Pub. Date: Jun. 20, 2002

(54) Method and system for calculating licensing fee of digital contents and medium recorded with operational program for the method and system

(76) Inventors: Nobuya Okayama, Kawasaki (JP); Hiroya Onimaru, Owariasahi (JP); Masayuki Orimo, Kawasaki (JP); Jun?apos; ichi Kinoshita, Tokyo (JP); Hisamitsu Kawaguchi, Sagamihara (JP); Tatsuro Arai, Ebina (JP); Hiroshi Koike, Maebashi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/923,457

(22) Filed: Aug. 8, 2001

(30) Foreign Application Priority Data
Dec. 19, 2000 (JP) 2000-389954

(51) Int. Cl. G06F 17/60

(52) U.S. Cl. 705/59

(57) ABSTRACT

Digital contents are distributed from a center side distribution apparatus to a terminal apparatus via a shop side distribution apparatus, an audiovisual fee for digital contents with limited time is collected from a user, all digital contents capable of being accessed only at a limited place are allowed to be viewed and listened during a limited time period, the number of audiovisual times of digital contents viewed and listened at the terminal apparatus is managed, the numbers of audiovisual times of digital contents are totaled, and a copyright fee is calculated in accordance with the totalized number of audiovisual times. It is therefore possible to reliably collect a copyright fee even in the shop such as a manga tea shop and a compound cafe at which the copyright fee was not able to be collected to date. It is also possible to strictly manage viewing and listening digital contents.

### BACKGROUND OF THE INVENTION

1. Field of the Invention

The present invention relates to techniques of calculating licensing fee of digital contents.

2. Description of the Related Art

Developments of communications such as the Internet, PDA and portable terminals allow the advent of a system of distributing and selling digital contents. Recently, music distribution businesses are appearing and it is conceivable that distribution of various digital contents is performed in the future.

Techniques of collecting an audiovisual fee for digital contents for other companies are disclosed in JP-A-11-66182 (NTT Data Corporation, Nippon Telegram and Telephone Corp.). This application pays attention to charging a user using digital contents, and does not teach collecting an audiovisual fee for leasing digital contents.

In a shop such as a manga (cartoon) tea shop and a compound cafe having a large amount of digital contents such as books, games and DVD's, even if a user uses the contents, a copyright fee is not collected. This is because the manga tea shop or compound cafe has as its business object a food and drink business, and a large amount of contents is only the material to be viewed and listened freely. For users of a tea shop or the like, the shop is only the place to take a rest or kill time, and the users have no object of viewing and listening the contents. However, a manga tea shop and a compound cafe have a different object from a general tea shop, the object being to view and listen a large amount of contents.

If there is a print on-demand request for an electronic book which is one example of digital contents, in order to print only one page or copy all pages or bind a book, some request cannot be accepted because the method of collecting a copyright fee is not still established. The above-described techniques cannot deal with viewing and listening only a portion of contents, for example, in the case of an electronic book, cannot deal with viewing and listening in the unit of page.

### SUMMARY OF THE INVENTION

It is an object of the present invention to provide a method and system for calculating licensing fee of digital contents capable of solving the above problems and collecting a copyright fee.

In order to achieve the above object of the invention, there is provided a method for calculating licensing fee of digital contents comprising: a step of distributing digital contents from a center side distribution apparatus to a terminal apparatus via a shop side distribution apparatus; a step of collecting an audiovisual fee for digital contents with limited time from a user; a step of allowing all digital contents capable of being accessed only at a limited place to be viewed and listened during a limited time period; a step of managing the number of audiovisual times of digital contents viewed and listened at the terminal apparatus; a step of totalizing the number of audiovisual times of digital contents; and a step of calculating a copyright fee in accordance with the totalized number of audiovisual times.

It is therefore possible to reliably collect a copyright fee even in the shop such as a mange tea shop and a compound cafe at which the copyright fee was not able to be collected to date. It is also possible to strictly manage viewing and listening digital contents.

### BRIEF DESCRIPTION OF THE DRAWINGS

FIG. 1 is a diagram showing the outline structure of a system for calculating licensing fee of digital contents with limited time and place according to an embodiment.

FIG. 2 is a diagram showing the outline structure of a center side distribution apparatus 100 of the embodiment.

FIG. 3 is a diagram showing the outline structure of a shop side distribution apparatus 110 of the embodiment.

FIG. 4 is a diagram showing the outline structure of a terminal apparatus 120 of the embodiment.

FIG. 5 is a flowchart illustrating a process of charging a use time of a user according to the embodiment.

FIG. 6 is a flowchart illustrating a process of calculating the number of audiovisual times of digital contents according to the embodiment.

FIG. 7 is a flowchart illustrating a process of transferring data between the center side distribution apparatus and shop side distribution apparatus according to the embodiment.

FIG. 8 is a diagram showing an example of shop management data according to the embodiment.

FIG. 9 is a diagram showing an example of audiovisual check parameters according to the embodiment.

FIG. 10 is a diagram showing an example of shop management data generated by the shop side distribution apparatus 110 according to the embodiment.

FIG. 11 is a diagram showing an example of user resident time data generated by the shop side distribution apparatus 110 according to the embodiment.

FIG. 12 is a diagram showing an example of digital contents data according to the embodiment.

FIG. 13 is a diagram showing an example of a user portable recording medium according to the embodiment.

### DETAILED DESCRIPTION OF THE EMBODIMENTS

A licensing fee calculating system for digital contents with limited time and place according to an embodiment of the invention will be described. The term “digital contents” used in this specification is intended to mean digitalized contents such as electronic books, music, images and games.

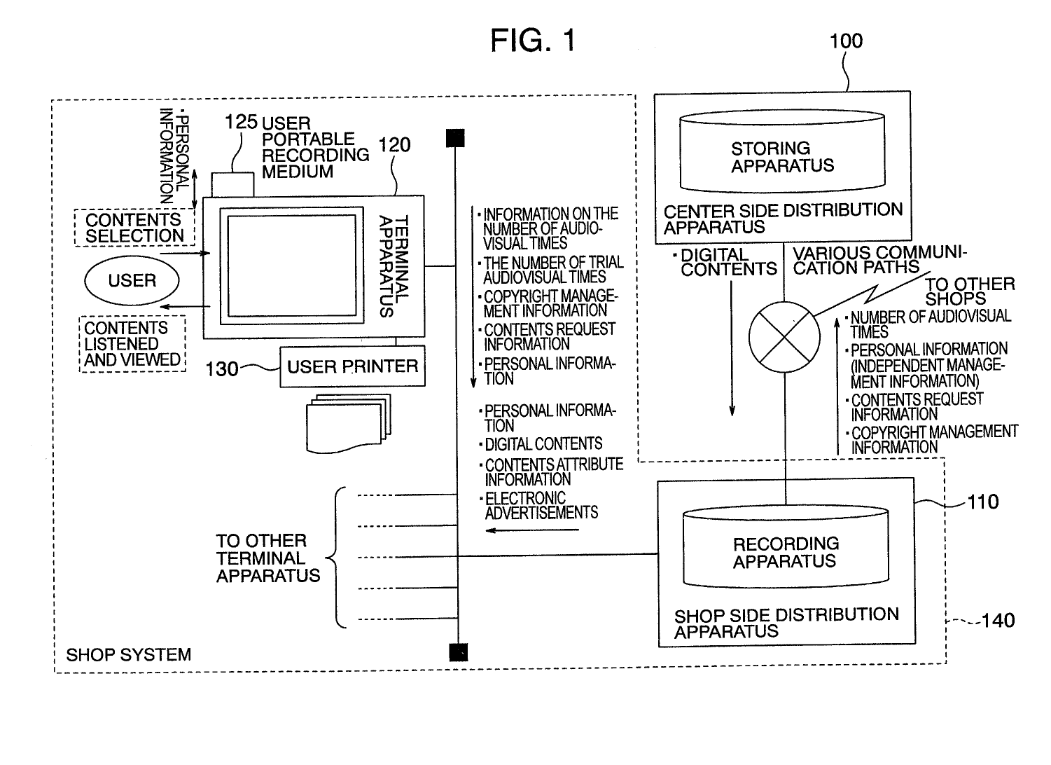

FIG. 1 is a diagram showing the outline structure of a licensing fee calculating system for digital contents with limited time and place according to the embodiment. As shown in FIG. 1, the licensing fee calculating system for digital contents with limited time and place has a center side distribution apparatus 100 and a shop system 140. The shop system 140 has a shop side distribution apparatus 110, a terminal apparatus 120, a user portable recording medium 125 for making the terminal apparatus read member information, and a user printer 130 connected to the terminal apparatus.

The center side distribution apparatus 100 distributes digital contents to a plurality of shop side distribution apparatus 110 via various communication paths. If the number of shops is several hundreds to several thousands, broadcast distribution using a satellite can save cost and time. This distribution is performed periodically or upon urgent request. Although on-demand satellite distribution is possible, it is not practical if the number of shops is several hundreds to several thousands. In this case, it is practical to use a private line of higher speed for on-demand distribution.

The shop side distribution apparatus 110 stores digital contents transmitted from the center side distribution apparatus 100 in a database of a magnetic disk drive.

The shop side distribution apparatus 110 transmits on-demand digital contents to the user terminal apparatus, by appending electronic advertisements of the category which is considered from user information to be most interested. In this manner, it is possible to make the user view and listen the electronic advertisements suitable for the user, together with the digital contents. In exchanging secure data, the center side distribution apparatus 100 enciphers the data, and the shop side distribution apparatus 110 or terminal apparatus 120 deciphers it.

Only when the shop side distribution apparatus 110 is connected to the center side distribution apparatus 100 on line, it is possible to transmit the number of audiovisual times of digital contents, personal information, and copyright management information. The personal information is being written in the user portable recording medium 125 and the user can carry it. This user portable recording medium 125 can be used at other shops having the terminal apparatus of the same or similar type. The user portable recording medium may be various portable media such as IC cards, magnetic cards, ID cards, card-type CD-ROM's, PCMCIA cards and MMC cards. The personal information includes user operation history, user contents selection history, user preference information, and the like.

The terminal apparatus 120 transmits the number of audiovisual times of digital contents, copyright management information which manages the copyright owner, contents request information, personal information, and action history management information which manages the pages read by the user and the page presently read by the user, to the shop side distribution apparatus 110.

The user printer 130 connected to the terminal apparatus 120 is used for printing upon print on-demand. The digital contents capable of print on-demand are digital contents capable of being printed, such as electronic books and electronic magazines. Prices of digital contents selected by the user for print on-demand by using the terminal apparatus 120 are acquired from the shop side distribution apparatus 110. The acquired prices are displayed on the display of the terminal apparatus 120. The prices include a price of the print on-demand digital contents and a total price of the price of the print on-demand digital contents and a price of a printed-out on-demand digital contents. If print on-demand is not possible, a message that the print is not possible is displayed on the display of the terminal apparatus 120. Print information indicating what digital contents were printed is written in the user portable recording medium 125 connected to the terminal apparatus 120. Print on-demand contents are printed out from the user printer 130 connected to the terminal apparatus 120. Information on the printed contents is transmitted to the shop side distribution apparatus 110 as the copyright management information.

The shop system 140 is a collective name of the whole shop as viewed from the center side distribution apparatus. The shop system has the shop side distribution apparatus 110 for data transfer to and from the center side distribution apparatus and a plurality of terminal apparatus 120 installed in the shop.

When a user uses digital contents at the terminal apparatus 120, electronic advertisements can be buried in the digital contents. In burying electronic advertisements in digital contents, the terminal apparatus 120 first transmits the user ID number to the shop side distribution apparatus 110. The shop side distribution apparatus 110 searches the personal information by using the ID number, selects suitable electronic advertisements by using the personal information, and synthesizes or compounds the electronic advertisements and digital contents requested by the user. The synthesized or compounded digital contents are distributed to the terminal apparatus 120 so that it becomes possible to make the user view and listen the digital contents buried with the electronic advertisements.

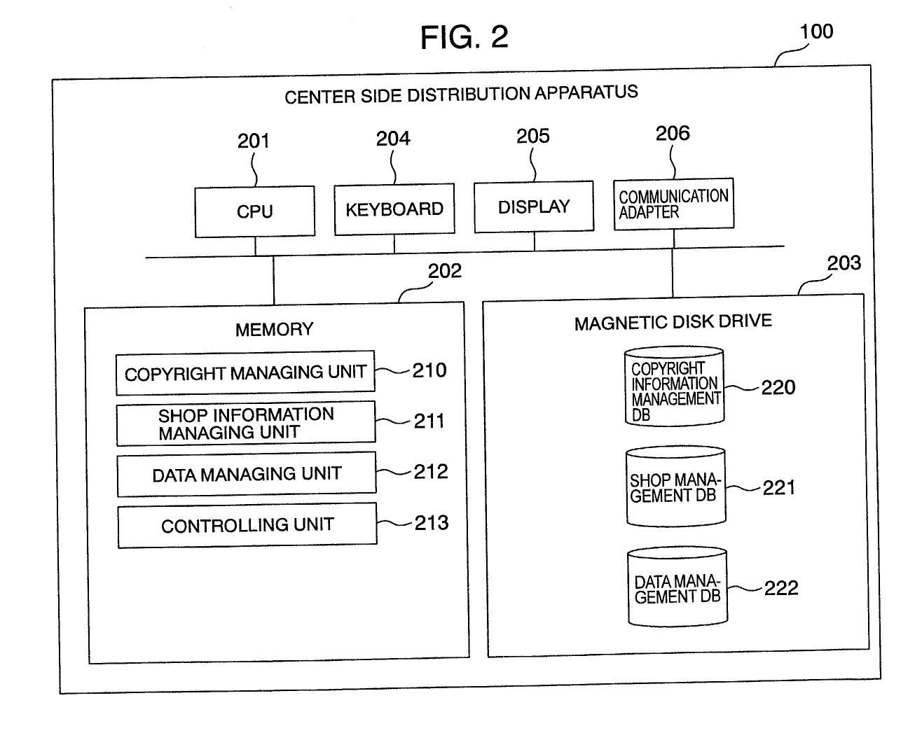

FIG. 2 is a diagram showing the outline structure of the center side distribution apparatus 100 of the embodiment. As shown in FIG. 2, the center side distribution apparatus 100 has a CPU 201, a memory 202, a magnetic disk drive 203, a keyboard 204, a display 205 and a communication adapter 206.

CPU 201 is a control unit for controlling the whole operation of the center side distribution apparatus 100. The memory 202 is a storage unit for loading various process programs and data for controlling the operation of the center side distribution apparatus 100. The magnetic disk drive 203 is a recording unit for storing various process programs and various digital contents. The keyboard 204 is an input unit for inputting an operation command and the like for the center side distribution apparatus 100. The communication adapter 206 is an adapter for performing communications with other apparatus.

The center side distribution apparatus 100 has a copyright managing unit 210, a shop information acquiring unit 211, a data managing unit 212 and a controlling unit 213.

The copyright managing unit 210 manages the number of audiovisual times of each shop and the number of audiovisual times of all shops in accordance with the number of audiovisual times of each of digital contents of all shops transmitted from all shop side distribution apparatus 110. The copyright managing unit 210 also calculates a copyright fee of digital contents and manages the fee of digital contents sent or transferred from shops.

The shop information managing unit 211 stores various information transmitted from the shop side distribution apparatus 110 in a copyright information management DB 220, a shop management DB 211 and a data management DB 222. For example, the information includes the number of audiovisual times, personal information (action history information), a list of contents requested to be distributed by the shop, and shop information. The shop information managing unit 211 also manages the digital contents to be distributed to each shop. For example, if the digital contents capable of distributing at each shop are managed in accordance with the type of contracts and some shop requests digital contents not contracted, the shop information managing unit 211 rejects digital contents distribution.

The data managing unit 212 manages digital contents, their attribute information, electronic advertisements, digital contents synthesizing or compounding electronic advertisements, and transfers data to and from the copyright information management DB 220, shop management DB 211 and data management DB 222. If digital contents data, personal information, the number of audiovisual times, shop information and the like all enciphered are to be transferred to and from the shop side distribution apparatus 110, an enciphering function is added to the data managing unit 212. In this case, a deciphering function is required to be added.

The controlling unit 213 controls the whole of the center side distribution apparatus 100 including the processing units in the memory 202, magnetic disk drive 203, keyboard 204, display 205 and communication adapter 206. The controlling unit 213 also controls to receive a digital contents request, proceeds, personal information and the like transmitted from the shop side distribution apparatus 110.

The copyright information management DB 220 manages a copyright owner of each of digital contents and a copyright fee of each of digital contents. It also manages how much money is sent or transferred to what place and to which copyright owner, and information on the number of licensing times including the number of audiovisual times, the number of transmission times and the number of request times, respectively of digital contents. A copyright fee of digital contents is managed in order to allow listening and viewing a portion of digital contents and print on-demand.

The shop management DB 221 manages all information of shops such as a shop name, a shop address, the amount of digital contents stored in the shop side distribution apparatus, and proceeds of each shop. The shop management DB 221 also manages personal information (action history information) transmitted from each shop.

The data management DB 222 manages digital contents, their attribute information, electronic advertisements, their attribute information, and regulation information of each of digital contents. The regulation information of each of digital contents is, for example, information of regulating adult digital contents to users of 18 years or older or information of distributing some digital contents only to shops in a particular district.

It is assumed that a program for providing the functions of the copyright managing unit 210, shop information acquiring unit 211, data managing unit 212 and controlling unit 213 of the center side distribution apparatus 100 is written in the recording medium such as a CD-ROM and stored in a magnetic disk or the like and then loaded in the memory to be executed. Instead of CD-ROM, the program may be written in other media such as a DVD and a DAT.

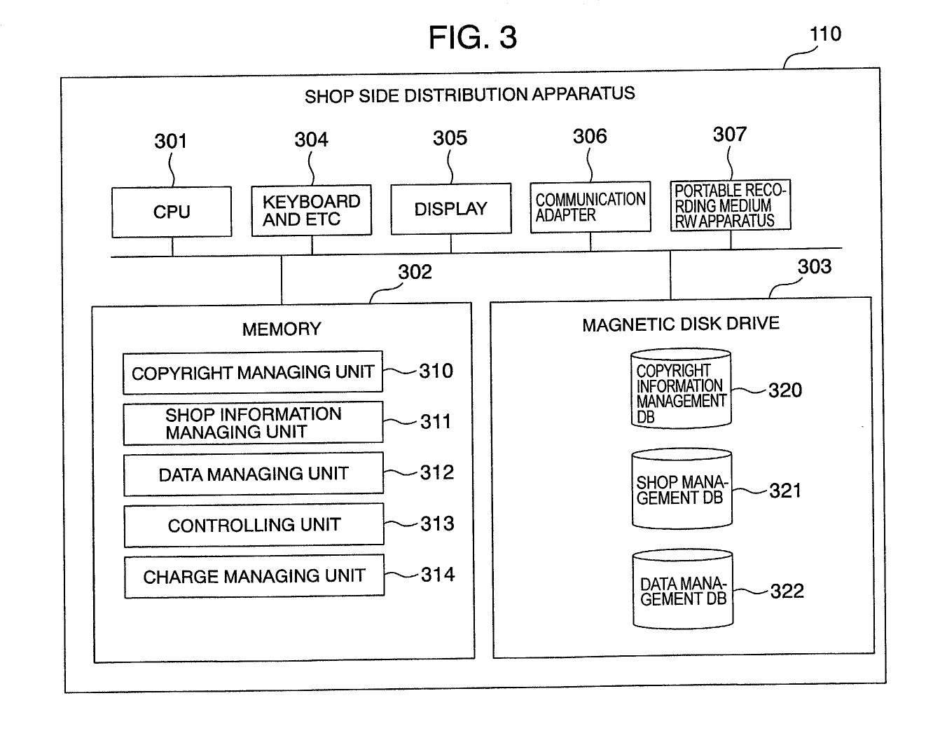

FIG. 3 is a diagram showing the outline structure of the shop side distribution apparatus 110 of the embodiment. As shown in FIG. 3, the shop side distribution apparatus 110 of this embodiment has a CPU 301, a memory 302, a magnetic disk drive 303, a keyboard and etc 304, a display 305, a communication adapter 306 and a portable recording medium RW (read write) apparatus 307.

CPU 301 is a control unit for controlling the whole operation of the shop side distribution apparatus 110. The memory 302 is a storage unit for loading various process programs and data for controlling the operation of the shop side distribution apparatus 110. The magnetic disk drive 303 is a recording unit for storing various process programs and various digital contents. The keyboard or etc. 304 is an input unit for inputting an operation command and the like for the shop side distribution apparatus 110, and may be an input unit of a ten-key type, a telephone type or POS. The communication adapter 306 is an adapter for performing communications with other apparatus. The portable recording medium RW apparatus 307 is a unit for reading and writing data from and to the user portable recording medium.

The shop side distribution apparatus 110 has a copyright managing unit 310, a shop information acquiring unit 311, a data managing unit 312, a controlling unit 313 and a charge managing unit 314.

The copyright managing unit 310 calculates a copyright fee of digital contents from the number of audiovisual times of the digital contents transmitted from the terminal apparatus 120, and manages a use fee of digital contents to be received at the shop and a use fee of digital contents to be sent or transferred to the center. It is assumed that the copyright managing unit 310 of the shop side distribution apparatus 110 deals with the numbers of audiovisual times only at the terminal apparatus 120 connected to the shop side distribution apparatus.

The shop information managing unit 311 stores various information transmitted from the terminal apparatus 120. For example, the information includes the number of audiovisual times, personal information (action history information), shop information such as shop ID and shop address, and management information of the terminal apparatus 120 installed in the shop. The shop information managing unit 311 also manages the digital contents to be distributed to each terminal apparatus 120. For example, the digital contents usable by each user is restricted in accordance with an entrance fee (use fee), or if a young user in the shop requests adult digital contents, digital contents distribution is rejected.

The data managing unit 312 manages digital contents, their attribute information, electronic advertisements, and digital contents synthesizing or compounding electronic advertisements, and transfers data to and from a copyright information management DB 320, a shop management DB 321 and a data management DB 322. If digital contents data, personal information, the number of audiovisual times, shop information and the like all enciphered are to be transferred between the terminal apparatus 120 and shop side distribution apparatus 110, an enciphering function is added to the data managing unit 312. In this case, a deciphering function is required to be added.

The controlling unit 313 controls the whole of the shop side distribution apparatus 110 including the processing units in the memory 302, magnetic disk drive 303, keyboard 304, display 305 and communication adapter 306. The controlling unit 313 also controls to receive a digital contents request, proceeds, personal information and the like transmitted from the terminal apparatus 120.

The copyright information management DB 320 manages a copyright owner of each of digital contents and a copyright fee of each of digital contents. It also manages how much money is sent or transferred to what place and to which copyright owner, and information on the number of licensing times including the number of audiovisual times, the number of transmission times and the number of request times, respectively of digital contents. A copyright fee of digital contents is managed in order to allow listening and viewing a portion of digital contents and print on-demand.

The shop management DB 321 manages all information of the shop such as a shop name, a shop address, the amount of digital contents stored in the shop side distribution apparatus, and proceeds of the shop. The shop management DB 321 also manages personal information (action history information) transmitted from the terminal apparatus 120.

The data management DB 322 manages digital contents, their attribute information, electronic advertisements, their attribute information, and regulation information of each of digital contents. The regulation information of each of digital contents is, for example, information of regulating adult digital contents only to users of 18 years or older or information of distributing some digital contents only to shops in a particular district.

It is assumed that a program for providing the functions of the copyright managing unit 310, shop information acquiring unit 311, data managing unit 312 and controlling unit 313 of the shop side distribution apparatus 110 is written in the recording medium such as a CD-ROM and stored in a magnetic disk or the like and then loaded in the memory to be executed. Instead of CD-ROM, the program may be written in other media such as a DVD and a DAT.

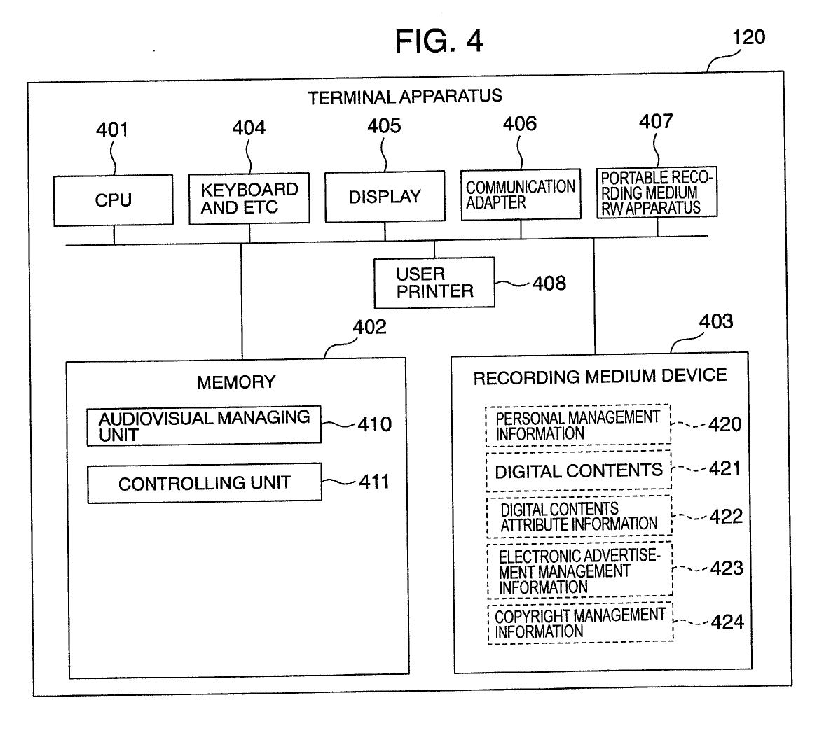

FIG. 4 is a diagram showing the outline structure of the terminal apparatus 120 of the embodiment. As shown in FIG. 4, the terminal apparatus 120 of the embodiment has a CPU 401, a memory 402, a recording medium device 403, a keyboard and etc 404, a display 405, a communication adapter 406, a portable recording medium RW (read write) apparatus 407 and a printer 408. The portable recording medium RW (read write) apparatus 407 and printer 408 are optional.

CPU 401 is a control unit for controlling the whole operation of the terminal apparatus 120. The memory 402 is a storage unit for loading various process programs and data for controlling the operation of the terminal apparatus 120. The recording medium device 403 is a recording unit for storing various process programs and various digital contents. The keyboard or etc. 404 is an input unit for inputting an operation command and the like for the terminal apparatus 120, and may be a controller of a game machine, an input unit of a ten-key type, a telephone type or touch panel type. The communication adapter 406 is an adapter for performing communications with other apparatus. The portable recording medium RW apparatus 407 is a unit for reading and writing data from and to the user portable recording medium. The user printer 408 is a print unit for printing a portion or the whole of print on-demand contents selected by a user.

The terminal apparatus 120 has an audiovisual managing unit 410 and a controlling unit 411.

The audiovisual managing unit 410 is a unit for generating a search window and a window of a table of contents, selecting digital contents, and acquiring the digital contents from the shop side distribution apparatus 110. The audiovisual managing unit 410 manages digital contents, their attribute information, electronic advertisements, contents synthesizing or compounding electronic advertisements, personal information of each user transmitted from the shop side Off distribution apparatus 110, action history information of each user acquired from the user portable recording medium inserted into the portable recording medium RW apparatus 407, and the number of audiovisual times. If it is necessary to transfer enciphered data between the shop side distribution apparatus 110 and terminal apparatus 120, an enciphering function is added to the audiovisual managing unit 410. In this case, a deciphering function is required to be added.

The controlling unit 411 performs a display process of displaying contents on the display 405 of the terminal apparatus 120, a display control for the terminal apparatus, and a printer control for printing a portion or the whole of the digital contents selected by the user. Since some digital contents are inhibited to be printed or have a watermark which is inserted during printing, it is necessary to check attribute of the digital contents or whether the user has a printing rights.

The recording medium device 403 has personal management information 420, digital contents 421, digital contents attribute information 422, electronic advertisement management information 423, and copyright management information 424.

It is assumed that a program for providing the functions of the audiovisual managing unit 410 and controlling unit 411 of the terminal apparatus 120 is written in the recording medium such as a CD-ROM and stored in a magnetic disk or the like and then loaded in the memory to be executed. Instead of CD-ROM, the program may be written in other media such as a DVD and a DAT.

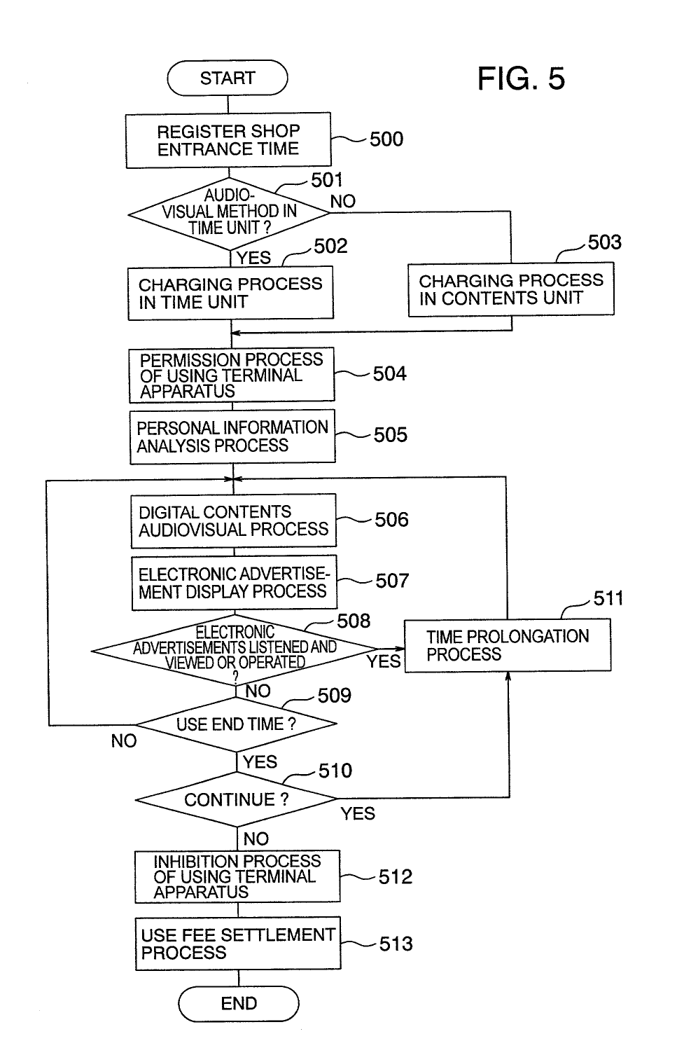

FIG. 5 is a flowchart illustrating a charging method of charging a user time of each user through a terminal control of digital contents to be executed by the copyright managing unit 310 of the shop side distribution apparatus 110 and the audiovisual managing unit 410 and the controlling unit 411 for controlling the contents display of the terminal apparatus 120, respectively of the shop system of this embodiment.

At Step 500, the charge managing unit 314 of the shop side distribution apparatus 110 registers a time when a user enters the shop, the time being entered by a shop manager by using the keyboard or etc 304. At the same time, if the user portable recording medium 125 is used, the time when a user enters the shop is registered in the user portable recording medium 125 via the portable recording medium RW apparatus 307.

At Step 501 the charging managing unit 314 of the shop side distribution apparatus 110 displays a method of viewing and listening digital contents on the display 305 to make the user select either a time unit or a contents unit of viewing and listening. The contents unit does not mean each of digital contents but it means a portion of each of digital contents. For example, in the case of an electronic book, the contents unit corresponds to only some page or a limited article.

If the audiovisual method selected at Step 501 is the time unit of viewing and listening, the flow advances to Step 502 whereat a time unit charging process is performed. In the time unit charging process at Step 502, the terminal apparatus 120 is subjected to charge setting so that the time unit charging process can be executed. If the audiovisual method of the contents unit is selected, the flow advances to Step 503 whereat a contents unit charging process is performed. In the contents unit charging process at Step 503, the terminal apparatus 120 is subjected to charge setting so that the contents unit charging process can be executed.

At Step 504 a process of allowing a user to view and listen digital contents in the time unit or contents unit is executed for the terminal apparatus 120. As a method of permitting a user to view and listen digital contents, a charging process in the time unit or contents unit is set to the user portable recording medium 125 issued to the user at the entrance time or in advance, and charging information is stored in the portable recording medium 125 by using the portable recording medium RW apparatus 307. Data written in the portable recording medium 125 is read via the portable recording medium RW apparatus 407 so that the terminal 120 is permitted to use. Since the user portable recording medium 125 has also a timer function, there is no problem if the user changes the terminal apparatus 120. If the user portable recording medium 125 is not issued to the user at the entrance time or in advance, the shop side distribution apparatus 110 transmits permission information to the terminal apparatus 120 to be used by the user so that the terminal apparatus 120 is permitted to be used. With this process, although the terminal apparatus 120 to be used by the user is limited, digital contents can be viewed and listened.

At Step 505 personal information is analyzed beforehand at the shop information managing unit 311 of the shop side distribution apparatus 110 and the analyzed results are transmitted to the audiovisual managing unit 410 of the terminal apparatus 120. If it cannot know which terminal apparatus 120 is used by the user, data in the user portable recording medium 125 is read via the portable recording medium RW apparatus 407 of the terminal apparatus 120 and stored as personal management information 420 of the terminal apparatus 120. This personal management information 420 is acquired by the audiovisual managing unit 410 which analyzes this information.

At Step 506 by using the personal information acquired at Step 505 and the audiovisual managing unit 410 and controlling unit 411 of the terminal apparatus 120, the user is permitted to view and listen digital contents. After this permission, the digital contents requested by the user are inquired to the data managing unit 312 of the shop side distribution apparatus 110, acquired from the data management DB 322, and loaded in the recording medium device 403 of the terminal apparatus 120. The loaded digital contents are processed to form digital contents suitable for the user, by referring to the personal information and electronic advertisement management information. A method of calculating the number of audiovisual times will be described later at Steps 601 to 612.

Step 507 is a process of displaying electronic advertisements to be displayed on the terminal apparatus 120 at the same time when the digital contents are viewed and listened. In this process, how the user views and listens or operates the electronic advertisements is checked. In accordance with how the user views and listens or operates the electronic advertisements, a different incentive point is given to the user. As to viewing and listening electronic advertisements, an incentive point is given when the audiovisual time exceeds a predetermined time period. If the electronic book is clicked or some operation is performed, an incentive point is also given. Any operation may be given a large incentive point than only viewing and listening.

At Step 508 in order to reflect the incentive point given at Step 507 upon a time prolongation process, it is checked whether electronic advertisements are viewed and listened or operated. If the electronic advertisements are viewed and listened or operated, the flow advances to Step 511 whereat the audiovisual time prolongation process is executed. In this case, the charging process is not executed for this prolonged time. If the electronic advertisements are not viewed and listened or operated, the flow advances to Step 509.

Step 509 is a check step of checking whether the use time of the terminal apparatus 120 used by the user is in the range of a permission time of the user. If the use time is in the range of the permission time, the flow returns to Step 506 whereat the digital contents audiovisual process is executed. If the use time is out of the range of a permission time, then at Step 510 it is confirmed whether the user continues the audiovisual process of digital contents. If all the permission time of the user is consumed, the terminal apparatus 120 may be forcibly stopped and made unusable without confirming whether or not the user continues the audiovisual process.

If a continuation operation is performed by the terminal apparatus 120 during the continuation check at Step 510, then the flow advances to Step 511 whereat the audiovisual time prolongation process is executed. At Step 511 by using the audiovisual managing unit 410 and controlling unit 411, the terminal control information is overwritten to prolong the audiovisual time of digital contents. At the same time, this time prolongation is notified to the copyright managing unit 310 and controlling unit 313 of the shop side distribution apparatus 110, and written in the copyright management DB 320 and shop management database DB 321. When all the permission time is consumed, this information is notified to the user. However, this process is not convenient for the user. To solve this, at Step 506 when the remaining time of the use time takes some standard value (e.g., before five minutes), a dialog box of continuation and termination is displayed on the display 405 of the terminal apparatus to allow the user select either continuation or termination with the keyboard or etc 404. If the user selects the continuation, the audiovisual prolongation information of digital contents is written in the user portable recording medium 125. If the user selects the termination, data is transmitted to the controlling unit 411 for controlling the contents display and terminal apparatus so that the terminal apparatus 120 is made unusable when all the use time is consumed (Step 512).

At Step 513 the use fee is settled for the user selected the continuation or termination. When the user finally returns the user portable recording medium 125 or the user goes out of the shop, the continued time is stored in the user portable recording medium 125. Synchronization is established at desired timings between the terminal apparatus 120 and shop side distribution apparatus 110, so that all the information stored in the user portable recording medium 125 is stored in the shop management DB 321 of the shop side distribution apparatus 110. The synchronization timings are when the user portable recording medium is recognized via the portable recording medium RW apparatus 407 of the terminal apparatus 120 and when it is recognized via the portable recording medium RW apparatus 307 of the shop side distribution apparatus 110 at the time of charge settlement. If the charging process in the contents unit is selected at Step 501, the use fee is calculated in according with the audiovisual amount of digital contents or the number of audiovisual contents. The use fee calculation is performed by using the number of audiovisual times calculated at Steps 601 to 612.

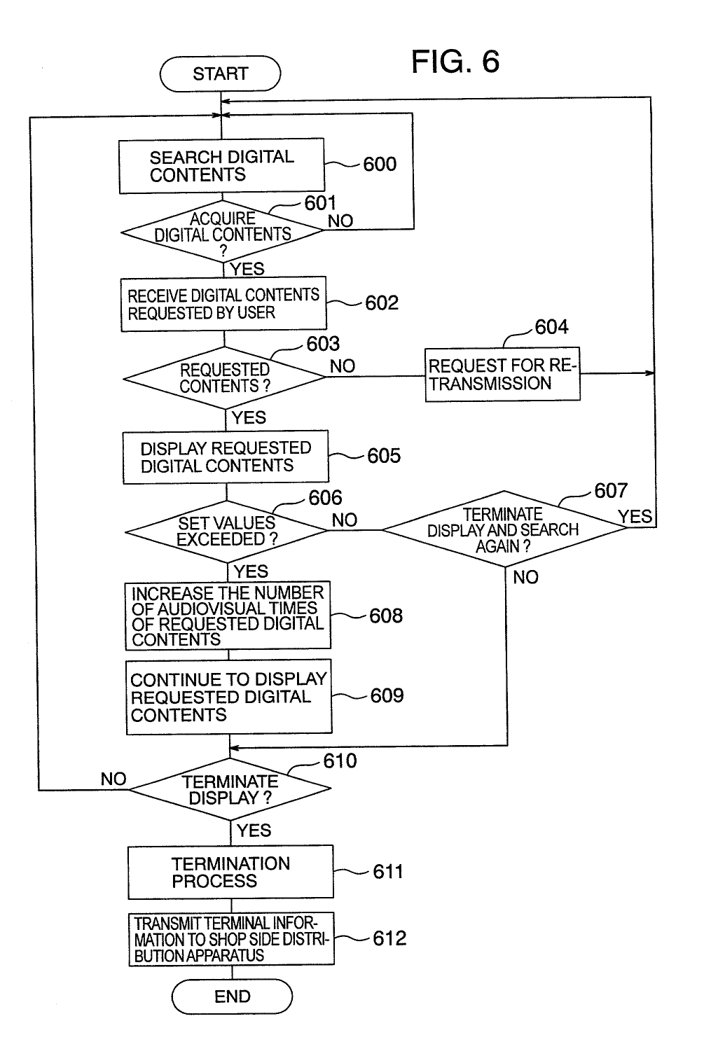

FIG. 6 is a flow chart illustrating a process of calculating the number of audiovisual times of digital contents in the shop system 140 having the shop side distribution apparatus 110 and a plurality of terminal apparatus 120 of this embodiment. This flowchart corresponds to a subroutine at Step 506 shown in FIG. 5.

At Step 600, if the audiovisual managing unit 410 of the terminal apparatus 120 has a search request for digital contents, the data managing unit 312 of the shop side distribution apparatus 110 searches the data management DB 322 in accordance with the search request and transmits the search results to the terminal apparatus 120. The user selects digital contents from the search results.

Step 601 is a step of judging whether or not the digital contents selected by the user from the search results are to be acquired. If the selected digital contents are to be acquired, the flow advances to Step 602. If different digital contents are to be acquired, the flow returns to Step 600. At Step 602, the audiovisual managing unit 410 of the terminal apparatus 120 receives the requested digital contents data from the data managing unit 312 of the shop side distribution apparatus 110.

At Step 603 it is checked whether the received digital contents are the requested digital contents. If the received digital contents are not the requested digital contents, the flow advances to Step 604 whereat a request for sending again digital contents is issued. If the received digital contents are the requested digital contents, the flow advances to Step 605 whereat the digital contents are stored in the recording medium device 403.

At Step 606 it is checked whether the audiovisual display exceeds the set value of each attribute of various audiovisual check parameters 900 (FIG. 9) which are used for judging whether the user actually viewed and listened digital contents. With this check process, the user can view and listen the digital contents in a trial base. If the user stops the display of the digital contents and if the audiovisual display does not exceed the set values of an audiovisual amount 902 and a minimum time 903 for adding the number of audiovisual times, respectively of the audiovisual check parameters 900, and also the time stored in the recording medium device 403 of the terminal apparatus 120, then it is judged that the audiovisual display does not exceed the set values and the flow advances to Step 607.

At Step 607 if different digital contents are searched again, the flow returns to Step 600. The value of each attribute of the audiovisual check parameters 900 can be set by the center side distribution apparatus. If the user continues the audiovisual display and this audiovisual display exceeds the set values of the audiovisual amount 902 and the minimum time 903 for adding the number of audiovisual times, respectively of the audiovisual parameters 900, then the flow advances to Step 608.

At Step 608 a process of increasing the number of audiovisual times of the digital contents now under display is executed. For example, the number of audiovisual times of stream data such as a movie is increased in the unit of scene or story. In this case, the number of audiovisual times is incremented by 1 when the whole of the movie is viewed and listened. Therefore, a percentage of a scene or story occupied in the movie is calculated and added. The calculation equation is “the number of audiovisual times to be increased=(time of a scene or story)/(total time)”. Similarly, in the case of an electronic book, the calculation equation is “the number of audiovisual times to be increased=(the number of read pages)/(total pages)”.

At Step 609 the requested digital contents continue being displayed on the display 405 so that the user can continue to view and listen the digital contents. Step 610 is a step of judging whether the digital contents requested at the terminal apparatus 120 continue to be displayed. If the user judges that the digital contents continue to be viewed and listened, the flow returns to Step 600, whereas if the user judges that the digital contents are terminated, the controlling unit 411 of the terminal apparatus 120 controls to terminate the display on the display 405.

At Step 611 a termination process is executed. In this process, the audiovisual managing unit 410 stores the personal information including the personal action history information as the personal management information 420. A cumulative use time and the total number of audiovisual times of digital contents at the terminal apparatus 120 are also written in the recording medium device 403 as the copyright management information 424. If the user portable recording medium 125 is used, the personal management information 420 is written in the user personal recording medium 125. At Step 612, various information obtained at the termination process at Step 611 is transmitted to the shop side distribution apparatus 110.

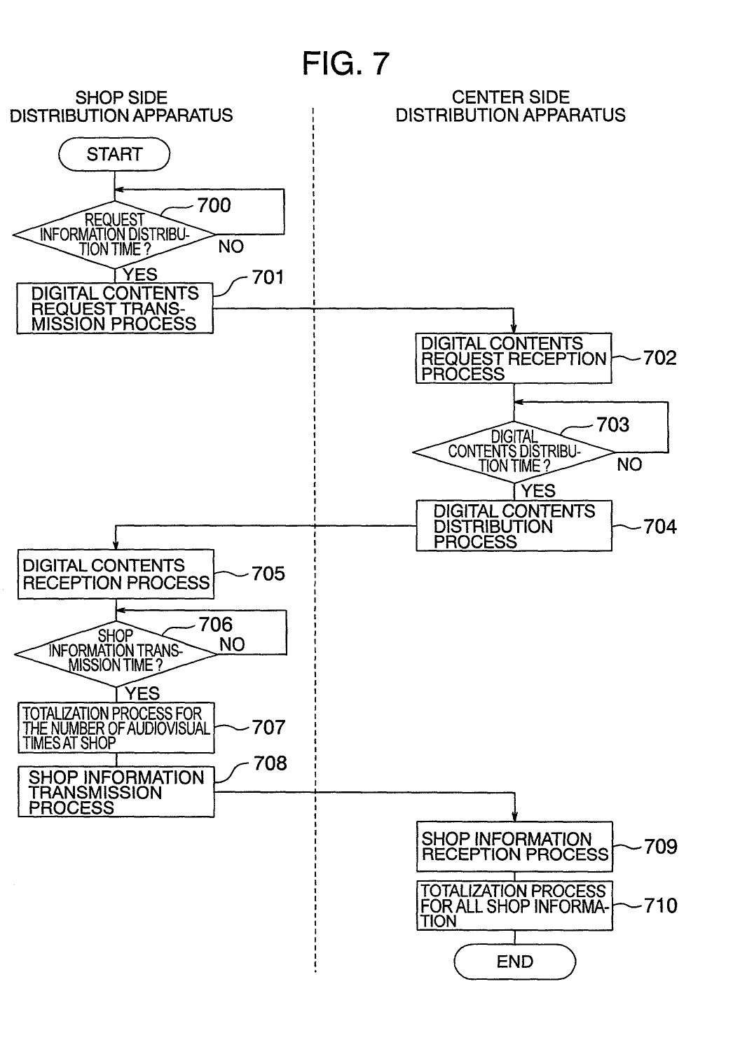

FIG. 7 is a diagram showing an example of a data flow regarding the request transmission of digital contents and the transmission/reception of the total number of audiovisual times of digital contents, between the center side distribution apparatus 100 and shop side distribution apparatus 110, according to the embodiment.

Step 700 is a step of performing communication scheduling for issuing a digital contents request to the center side distribution apparatus 100. At this Step 700 it is checked whether the present time is a time when the request is transmitted to the center side distribution apparatus 100. The transmission time is determined by initializing data from the center side distribution apparatus 100 to the shop side distribution apparatus 110 or at the time of installing the shop side distribution apparatus 110 in the shop. If the present time is not the transmission time, Step 700 is repeated. At the transmission time, the flow advances to Step 701.

At Step 701, distribution request information of digital contents requested at the terminal apparatus 120 or shop side distribution apparatus 110 is transmitted to the center side distribution apparatus 100 via the network.

At Step 702 the distribution request information processed at Step 701 is processed by the controlling unit 213 of the center side distribution apparatus 100. It is judged and decided from the received digital contents distribution request information as to which digital contents are to be distributed at the next digital contents distribution.

At Step 703 it is checked whether the present time is a time when digital contents are distributed to the shop side distribution apparatus 110. If not, Step 703 is repeated. At the distribution time, the flow advances to Step 704.

At Step 704, a process of distributing digital contents from the center side distribution apparatus 100 to the shop side distribution apparatus 110 is executed several times per day. If this process is executed once per day, digital contents may not be distributed to some shop side distribution apparatus 110 which send a distribution request. The number of distribution requests can be suppressed by executing the process several times per day. For the distribution of digital contents, communications means such as a satellite capable of broadcast distribution and/or broadband distribution are used.

At Step 705 the controlling unit 313 manages the reception process for the digital contents distributed at Step 704. After all the distributed digital contents are received, the flow advances to Step 706.

At Step 706 it is checked whether the present time is a time when shop information of the shop side distribution apparatus 110 is transmitted to the center side distribution apparatus 100. If not, Step 706 is repeated.

At the transmission time, the flow advances to Step 707.

At Step 707 a totalization process is executed periodically. In this process, the total number of audiovisual times stored in the shop side distribution apparatus 110 is obtained. The total number of audiovisual times for each of digital contents is obtained. After the totalization process, the flow advances to Step 708.

At Step 708 the total numbers of audiovisual times obtained at Step 707 are transmitted to the center side distribution apparatus 100. The controlling unit 313 transmits the total number of audiovisual times for each of digital contents to the controlling unit 213 of the center side distribution apparatus 100. The controlling unit 213 of the center side distribution apparatus 100 receives the numbers of audiovisual times (Step 709).

At Step 710, audiovisual information of digital contents transmitted from each shop side distribution apparatus 110 is again subjected to a totalization process for each of shops and each of digital contents. The totalized results are managed by the copyright managing unit 210 of the center side distribution apparatus 100.

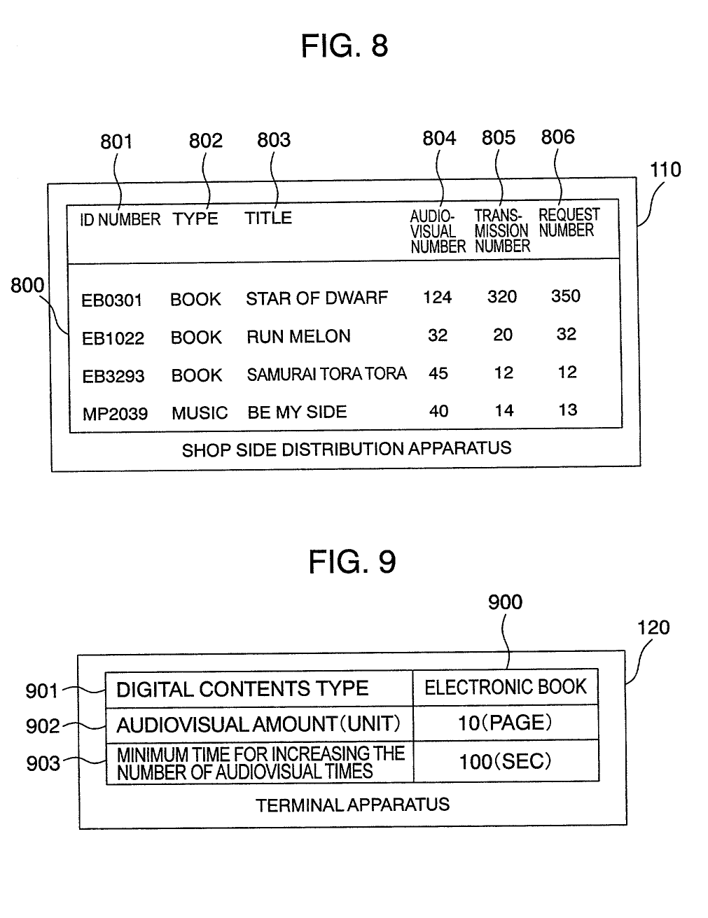

FIG. 8 is a diagram showing an example of information on the number of audiovisual times transferred between the shop side distribution apparatus 110 and terminal apparatus 120 and between the shop side distribution apparatus 110 and center side distribution apparatus 100. The shop side distribution apparatus 110 has a data table 800 which stores the number of times such as the number of audiovisual times, the number of transmissions and the number of requests, respectively of digital contents.

The table 800 for managing the number of audiovisual times of digital contents stores an ID number 801, a type 802, a title 803 of digital contents, the number 804 of audiovisual times, the number 805 of transmissions and the number 806 of requests.

The ID number 801 is used for identifying digital contents and has a unique number in this system. The type 802 shows the type of digital contents, such as electronic books, music and images available in this embodiment. The number 804 of audiovisual times shows the total number of audiovisual times of each of digital contents, this number being obtained by adding the actual numbers of audiovisual times. The number 805 of transmissions shows the number of digital contents requested by users from the terminal apparatus 120 and actually transmitted to the terminal apparatus 120. The number 806 of requests shows the number of digital contents requested by users from the terminal apparatus 120.

FIG. 9 is a diagram showing an example of various audiovisual check parameters which are used for judging whether digital contents are actually viewed and listened at the terminal apparatus 120 according to the embodiment.

The audiovisual check parameters 900 have a digital contents type 901, the audiovisual amount 902 and the minimum time 903 for increasing the number of audiovisual times. The digital contents type 901 is set with the type of digital contents obtained by the terminal apparatus 120 from the shop side distribution apparatus 110. The audiovisual amount 902 is a reference amount for assuming that the digital contents are viewed and listened. Each time the audiovisual amount of digital contents exceeds the set value (in this embodiment, 10 pages), it is assumed that the digital contents are actually viewed and listened, and the number of audiovisual times is increased. The minimum time 903 for increasing the number of audiovisual times is a reference time to be used for allowing the number of audiovisual times to be increased when the audiovisual state of digital contents at the terminal apparatus 120 exceeds the minimum time (in this embodiment, 100 seconds). If the audiovisual state of digital contents at the terminal apparatus 120 exceeds the audiovisual amount 902 or the minimum time 903 for increasing the number of audiovisual times, respectively of the audiovisual check parameter 900, then the number of audiovisual times is transmitted to the shop side distribution apparatus 110.

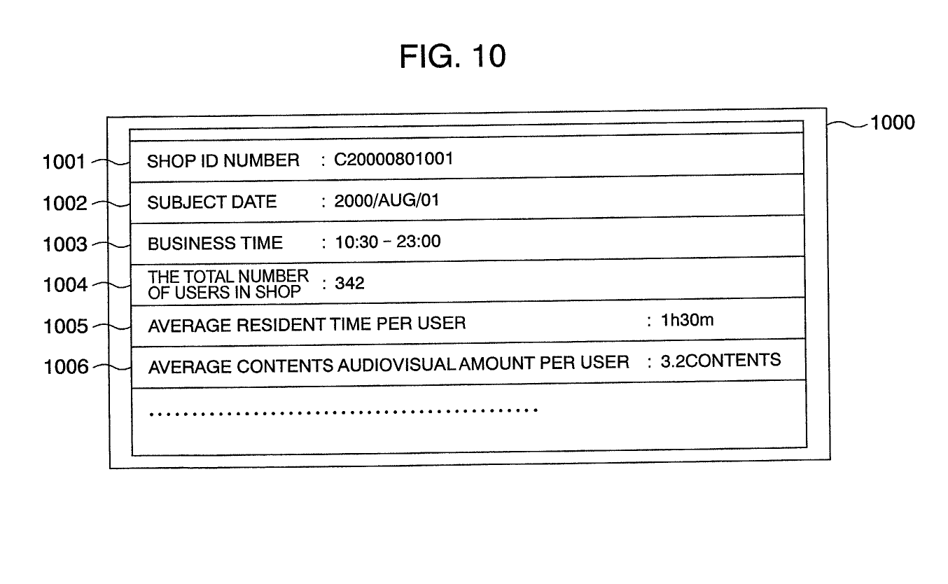

FIG. 10 is a diagram showing an example of shop management data generated by the shop information managing unit 311 of the shop side distribution apparatus 110 according to the embodiment. As shown in FIG. 10, the shop management data 1000 of this embodiment has a shop ID number 1001, a subject date 1002, a business time 1003, the total number 1004 of users, an average resident time 1005 per user, an average contents audiovisual amount 1006 per user.

The shop ID number 1001 is the number for identifying the shop side distribution apparatus. The subject date 1002 is a date on which shop management data is generated. The business time 1003 is the time during which the shop opens. The average resident time 1005 per user is obtained in cooperation with the shop information managing unit 311 of the shop side distribution apparatus 110. The average contents audiovisual amount 1006 per user is obtained in cooperation with the shop information managing unit 311 and copyright managing unit 310.

The shop management data 1000 is transmitted from the shop side distribution apparatus 110 to the center side distribution apparatus 100 every day or periodically. The transmitted shop management data 1000 is processed by the shop information managing unit 211 of the center side distribution apparatus 100 and stored in the shop management DB 221.

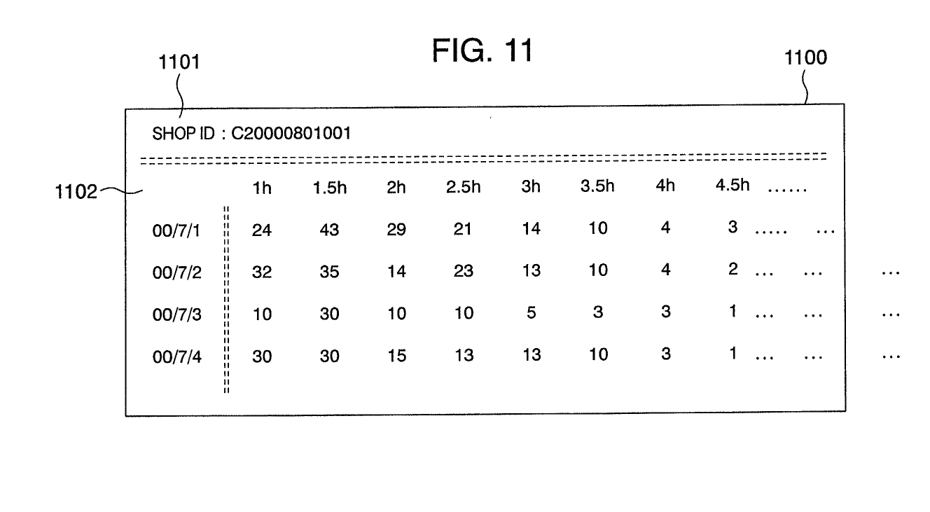

FIG. 11 is a diagram showing an example of user resident time data generated by the shop information managing unit 311 of the shop side distribution apparatus 110 according to the embodiment. As shown in FIG. 11, the user resident time data 1100 of this embodiment has a shop ID number 1101 and a user resident time table 1102 of each day.

The shop ID number 1101 is the number for identifying the shop side distribution apparatus. The user resident time table 1102 is obtained by checking an entrance time and exit time of each user of the shop.

The user resident time data 1100 is transmitted from the shop side distribution apparatus 110 to the center side distribution apparatus 100 every day or periodically. The transmitted user resident time data 1100 is processed by the shop information managing unit 211 of the center side distribution apparatus 100, passed to the copyright managing unit 210, and stored in the shop management DB 221.

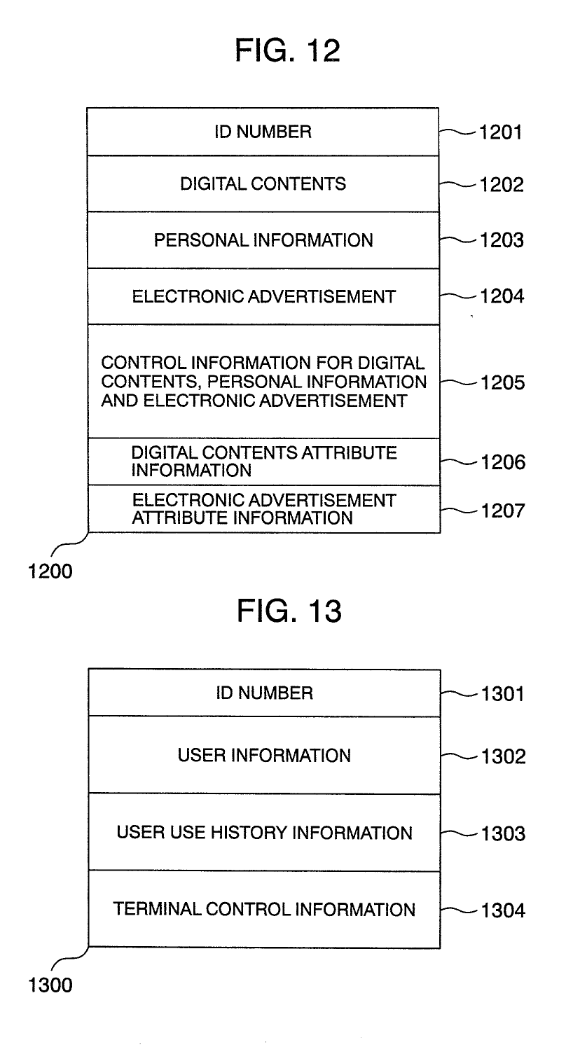

FIG. 12 is a diagram showing an example of digital contents data including personal information and an electronic advertisement according to the embodiment. As shown in FIG. 12, the digital contents data 1200 of this embodiment has an ID number 1201, digital contents 1202, personal information 1203, electronic advertisements 1204, control information 1205 for the digital contents, personal information and electronic advertisements, digital contents attribute information 1206 and electronic advertisement attribute information 1207.

The digital contents data 1200 is transmitted from the center side distribution apparatus 100 to the terminal apparatus 120 via the shop side distribution apparatus 110. The ID number 1201 is the number for identifying the digital contents data 1200. The digital contents 1202 are digital contents contained in the digital contents data 1200. The personal information 1203 includes personal information analyzed by the shop information managing unit 311 of the shop side distribution apparatus 110. By referring to the personal information, the terminal apparatus 120 can customize the electronic advertisements and digital contents for the user. The electronic advertisement 1204 is an electronic advertisement contained in the digital contents data 1200. The control information 1205 for the digital contents, personal information and electronic advertisements includes index information and control information such as information on what electronic advertisement corresponds to which part of the digital contents. The digital contents attribute information 1206 is attribute information added to the digital contents, such as category information of the digital contents. The electronic advertisement attribute information 1207 includes category information of the electronic advertisement and attribute information on the category of the digital contents to which the electronic advertisement belongs.

By using the control information 1205 for the digital contents, personal information and the electronic advertisement, the digital contents attribute information 1206 and the electronic advertisement attribute information 1207, the shop information managing unit 311 and data managing unit 312 of the shop side distribution apparatus 110 and the audiovisual managing unit 410 of the terminal apparatus 120 select digital contents and electronic advertisement.

In the example of the digital contents data shown in FIG. 12, the digital contents and electronic advertisements may be managed as compound contents.

FIG. 13 is a diagram showing an example of a user portable recording medium according to the embodiment. As shown in FIG. 13, a user portable recording medium 1300 of this embodiment has an ID number 1301, user information 1302, user use history information 1303 and terminal apparatus control information 1304.

The user portable recording medium 1300 is a medium for making the terminal apparatus 120 recognize the personal information of a user of the terminal apparatus 120. In order to make the terminal apparatus 120 recognize the data of the user portable recording medium 1300, the medium 1300 is inserted into the terminal apparatus or read by another media reader.

The ID number 1301 is information for identifying the user portable recording medium 1300, and is usually used as the ID number of the user. The user information 1302 includes personal information of the user, and service information such as points and discount rates corresponding to use frequencies. The user use history information 1303 includes a list of digital contents the user used and information on which category of digital contents was used. The terminal apparatus control information 1304 is used for controlling the terminal apparatus 120 to which the user was authenticated by using the user portable recording medium 1300, for example, controlling a use period, an available category of digital contents, a presence/absence of a limited operation.

As described so far, according to the digital contents licensing system with limited time and place of this embodiment, it is possible to manage the number of audiovisual times of digital contents viewed and listened by a user at the terminal apparatus, and to grasp which digital contents are used by what amount during some period. By transmitting the number of audiovisual times to the center side distribution apparatus, it is possible to calculate the number of audiovisual times of digital contents used at all shops for each copyright owner, so that the copyright fee can be paid reliably to the copyright owner.

Further, according to the digital contents licensing system with limited time and place of this embodiment, digital contents can be printed or copied to paper sheets under the copyright management, although the management of print or copy to paper sheets has been difficult conventionally. Users at remote islands or districts which take a long time to transport, can use digital contents at any time the user desires and at a low cost. Depending upon the category of digital contents, valuable contents and premier contents not circulated in the market can be viewed and listened.

The number of audiovisual times of digital contents viewed and listened by each user can be managed. Accordingly, the number of audiovisual times of used digital contents can be calculated for each copyright owner, and the copyright fee can be paid reliably to the copyright owner.

What is claimed is:

1. A calculating method of licensing fee of digital contents comprising:
a step of distributing digital contents from a center side distribution apparatus to a terminal apparatus via a shop side distribution apparatus;
a step of collecting an audiovisual fee for digital contents with limited time from a user;
a step of allowing digital contents capable of being accessed at a limited place to be viewed and listened during a limited time period;
a step of calculating the number of audiovisual times of digital contents viewed and listened at the terminal apparatus; and
a step of calculating a copyright fee in accordance with the calculated number of audiovisual times.

2. A calculating method of licensing fee of digital contents according to claim 1, further comprising a step of making the terminal apparatus recognize the contents of a portable recording medium storing an audiovisual period of viewing and listening digital contents at the terminal apparatus.

3. A calculating method of licensing fee of digital contents according to claim 1, further comprising a step of recording personal operation history information and personal preference information managed in the terminal apparatus in a portable recording medium.

4. A calculating method of licensing fee of digital contents according to claim 2, further comprising a step of recording personal operation history information and personal preference information managed in the terminal apparatus in the portable recording medium.

5. A calculating method of licensing fee of digital contents according to claim 1, further comprising a step of allowing a trial read of digital contents at the terminal apparatus capable of viewing and listening the digital contents.

6. A calculating method of licensing fee of digital contents according to claim 2, further comprising a step of allowing a trial read of digital contents at the terminal apparatus capable of viewing and listening the digital contents.

7. A calculating method of licensing fee of digital contents according to claim 3, further comprising a step of allowing a trial read of digital contents at the terminal apparatus capable of viewing and listening the digital contents.

8. A calculating method of licensing fee of digital contents according to claim 4, further comprising a step of allowing a trial read of digital contents at the terminal apparatus capable of viewing and listening the digital contents.

9. A calculating method of licensing fee of digital contents according to claim 1, further comprising a step of prolonging an audiovisual time of digital contents if an electronic advertisement is viewed and listened at the terminal apparatus capable of viewing and listening the digital contents.

10. A calculating method of licensing fee of digital contents according to claim 2, further comprising a step of prolonging an audiovisual time of digital contents if an electronic advertisement is viewed and listened at the terminal apparatus capable of viewing and listening the digital contents.

11. A calculating method of licensing fee of digital contents according to claim 3, further comprising a step of prolonging an audiovisual time of digital contents if an electronic advertisement is viewed and listened at the terminal apparatus capable of viewing and listening the digital contents.

12. A calculating method of licensing fee of digital contents according to claim 4, further comprising a step of prolonging an audiovisual time of digital contents if an electronic advertisement is viewed and listened at the terminal apparatus capable of viewing and listening the digital contents.

13. A calculating method of licensing fee of digital contents according to claim 5, further comprising a step of prolonging an audiovisual time of digital contents if an electronic advertisement is viewed and listened at the terminal apparatus capable of viewing and listening the digital contents.

14. A calculating method of licensing fee of digital contents according to claim 6, further comprising a step of prolonging an audiovisual time of digital contents if an electronic advertisement is viewed and listened at the terminal apparatus capable of viewing and listening the digital contents.

15. A calculating method of licensing fee of digital contents according to claim 7, further comprising a step of prolonging an audiovisual time of digital contents if an electronic advertisement is viewed and listened at the terminal apparatus capable of viewing and listening the digital contents.

16. A calculating method of licensing fee of digital contents according to claim 8, further comprising a step of prolonging an audiovisual time of digital contents if an electronic advertisement is viewed and listened at the terminal apparatus capable of viewing and listening the digital contents.

17. A calculating method of licensing fee of digital contents according to claim 1, further comprising a step of printing a portion or all of digital contents, a step of checking whether the digital contents can be printed, a step of calculating a copyright fee of the printed digital contents, and a step of displaying the calculated result on a display.

18. A calculating method of licensing fee of digital contents according to claim 2, further comprising a step of printing a portion or all of digital contents, a step of checking whether the digital contents can be printed, a step of calculating a copyright fee of the printed digital contents, and a step of displaying the calculated result on a display.

19. A calculating method of licensing fee of digital contents according to claim 3, further comprising a step of printing a portion or all of digital contents, a step of checking whether the digital contents can be printed, a step of calculating a copyright fee of the printed digital contents, and a step of displaying the calculated result on a display.

20. A calculating method of licensing fee of digital contents according to claim 4, further comprising a step of printing a portion or all of digital contents, a step of checking whether the digital contents can be printed, a step of calculating a copyright fee of the printed digital contents, and a step of displaying the calculated result on a display.

21. A calculating method of licensing fee of digital contents according to claim 5, further comprising a step of printing a portion or all of digital contents, a step of checking whether the digital contents can be printed, a step of calculating a copyright fee of the printed digital contents, and a step of displaying the calculated result on a display.

22. A calculating method of licensing fee of digital contents according to claim 6, further comprising a step of printing a portion or all of digital contents, a step of checking whether the digital contents can be printed, a step of calculating a copyright fee of the printed digital contents, and a step of displaying the calculated result on a display.

23. A calculating method of licensing fee of digital contents according to claim 7, further comprising a step of printing a portion or all of digital contents, a step of checking whether the digital contents can be printed, a step of calculating a copyright fee of the printed digital contents, and a step of displaying the calculated result on a display.

24. A calculating method of licensing fee of digital contents according to claim 8, further comprising a step of printing a portion or all of digital contents, a step of checking whether the digital contents can be printed, a step of calculating a copyright fee of the printed digital contents, and a step of displaying the calculated result on a display.

25. A calculating method of licensing fee of digital contents according to claim 9, further comprising a step of printing a portion or all of digital contents, a step of checking whether the digital contents can be printed, a step of calculating a copyright fee of the printed digital contents, and a step of displaying the calculated result on a display.

26. A calculating method of licensing fee of digital contents according to claim 10, further comprising a step of printing a portion or all of digital contents, a step of checking whether the digital contents can be printed, a step of calculating a copyright fee of the printed digital contents, and a step of displaying the calculated result on a display.

27. A calculating method of licensing fee of digital contents according to claim 11, further comprising a step of printing a portion or all of digital contents, a step of checking whether the digital contents can be printed, a step of calculating a copyright fee of the printed digital contents, and a step of displaying the calculated result on a display.

28. A calculating method of licensing fee of digital contents according to claim 12, further comprising a step of printing a portion or all of digital contents, a step of checking whether the digital contents can be printed, a step of calculating a copyright fee of the printed digital contents, and a step of displaying the calculated result on a display.

29. A calculating method of licensing fee of digital contents according to claim 13, further comprising a step of printing a portion or all of digital contents, a step of checking whether the digital contents can be printed, a step of calculating a copyright fee of the printed digital contents, and a step of displaying the calculated result on a display.

30. A calculating method of licensing fee of digital contents according to claim 14, further comprising a step of printing a portion or all of digital contents, a step of checking whether the digital contents can be printed, a step of calculating a copyright fee of the printed digital contents, and a step of displaying the calculated result on a display.

31. A calculating method of licensing fee of digital contents according to claim 15, further comprising a step of printing a portion or all of digital contents, a step of checking whether the digital contents can be printed, a step of calculating a copyright fee of the printed digital contents, and a step of displaying the calculated result on a display.

32. A calculating method of licensing fee of digital contents according to claim 16, further comprising a step of printing a portion or all of digital contents, a step of checking whether the digital contents can be printed, a step of calculating a copyright fee of the printed digital contents, and a step of displaying the calculated result on a display.

33. A calculating method of licensing fee of digital contents comprising a step of collecting an audiovisual fee of digital contents with limited time from a user, a step of outputting the digital contents during the limited time, a step of calculating the number of audiovisual times of the digital contents, and a step of calculating a copyright fee in accordance with the calculated number of audiovisual times.

34. A calculating method of licensing fee of digital contents comprising a step of counting the number of pages displaying digital contents and a step of calculating a fee from the number of displayed pages.

35. A calculating method of licensing fee of digital contents comprising a step of counting a display time during which digital contents are displayed and a step of calculating a fee in accordance with the display time.

36. A calculating system of licensing fee of digital contents comprising: means for distributing digital contents from a center side distribution apparatus to a terminal apparatus via a shop side distribution apparatus; means for collecting an audiovisual fee for digital contents with limited time from a user; means for allowing digital contents capable of being accessed at a limited place to be viewed and listened during a limited time period; means for calculating the number of audiovisual times of digital contents viewed and listened at the terminal apparatus; and means for calculating a copyright fee in accordance with the calculated number of audiovisual times.

37. A computer readable recording medium storing a program for calculating licensing fee of digital contents, the program comprising: a step of distributing digital contents from a center side distribution apparatus to a terminal apparatus via a shop side distribution apparatus; a step of collecting an audiovisual fee for digital contents with limited time from a user; a step of allowing digital contents capable of being accessed at a limited place to be viewed and listened during a limited time period; a step of calculating the number of audiovisual times of digital contents viewed and listened at the terminal apparatus; and a step of calculating a copyright fee in accordance with the calculated number of audiovisual times.
